(19) United States
(12) Patent Application Publication
(10) Pub. No.: US 2005/0198166 A1
(43) Pub. Date: Sep. 8, 2005

(54) Mail program, e-mail device, and method for managing e-mail messages

(75) Inventor: Akira Kawaji, Nara (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/986,168

(22) Filed: Nov. 12, 2004

(30) Foreign Application Priority Data
Nov. 14, 2003 (JP) P2003-385134

(51) Int. Cl. G06F 15/16

(52) U.S. Cl. 709/206

(57) ABSTRACT

To manage data received through e-mail and data received through means other than e-mail correctively by managing message body and attached files received through e-mail as separate files manageable by the OS. When an e-mail message is received, a command to convert and store the message body and its attached files into separate files is given (S27), and storage information of the files is added into an index table (S31). The message body of each e-mail message is stored in a storage folder as a file and an index showing the relation between files is created.

Japanese Patent Application No. 2003-385134 filed Nov. 14, 2003 is hereby incorporated by reference herein in its entirety.

### FIELD OF THE INVENTION

The present invention relates to an e-mail device using a computer and, more particularly, to a method for managing e-mail data.

### BACKGROUND OF THE INVENTION

Nowadays, e-mail is widely used for transmission of data. Data sent or received in the past can be searched by subject, sender, date of sending (one week before, for example) etc. using the search function of the e-mail software.

The operator creates folders in the computer to manage information other than information obtained through e-mail, such as data downloaded via the Internet or intranet. The information can be searched by file name or file creation date using the search function of the file management program in the OS.

In some cases, however, the operator may be uncertain whether a piece of information obtained in the past was obtained through e-mail or not. In such a case, it is impossible to make a search through both the information obtained through e-mail and the information obtained through means other than e-mail.

To solve the problem, an electronic data archive system as disclosed in JP-A-2001-344178 can be used.

This is a system which extracts the message body of a received e-mail message and stores it in a database. The device, however, has the problem that each data set is stored in two locations. Especially, since attached files are large in size, when the same data are stored in a folder in a storage area other than areas managed by the e-mail software, storage areas cannot be used effectively.

### SUMMARY OF THE INVENTION

It is an object of the present invention to provide a file management method by which information obtained through e-mail and information obtained through means other than e-mail can be comprehensively managed in files without a need for an extra data area, and a device for realizing the method.

An e-mail program according to the present invention is a program which extracts header information and message body from a given received e-mail message and stores them to cause a computer to manage the e-mail message, and has the following steps: a file creating and storing step of converting the message body into a message body file and storing it so that the OS can take out the data as a block, and an index adding step of adding a mail ID and header information of the e-mail message and file specifying information of its message body file into an index table.

An e-mail program according to the present invention is a program for extracting and storing the header information and message body from a received e-mail message, comprising the steps of: a file creating and storing step of converting the extracted message body into a message body file and storing the file, and an index adding step of adding the mail ID and header information of the e-mail message and the file specifying information of the message body file into an index table.

An e-mail program according to the present invention is a program for extracting and storing header information and message body from a received e-mail message, comprising the steps of: a file creating and storing step of converting the extracted message body into a message body file and storing the file, and an index adding step of adding a mail ID and header information of the e-mail message and file specifying information of the message body file into an index table.

An e-mail program according to the present invention is a program for giving commands to an OS extracting and storing a header information and message body from a received e-mail message, comprising the steps of: giving the OS a file creating and storing command to convert and store the extracted message body into a message body file, and giving the OS an index adding command to add a mail ID and header information of the e-mail message and file specifying information of the message body file into an index table.

An e-mail program according to the present invention is a program for extracting and storing the header information message body and a path and file name of an attached file or path and file names of attached files from a received e-mail message, comprising the steps of: a step of converting the extracted message body into a e-mail message and storing the message body file, a step of extracting the attached file(s) from the e-mail message and storing the attached file(s) separate from the message body file, a step of adding a mail ID and header information of the e-mail message and file specifying information of the message body file into an index table, and a step of linking the message body file and the attached file(s) so that an OS.

An e-mail program according to the present invention comprises the steps of: A) giving the OS a command to read out an index table in which a1) the header information of each received e-mail message, a2) a path and file name of a message body file containing the message body of the e-mail message, and a3) a path and file name of an attached file or path and file names of attached files attached to the message body are recorded in association with one another from a storage area, and B) giving the OS a command, in response to a command to move a file stored in the storage area to a different folder, to move the file and to change the path name of the file in the index table to a name corresponding to the destination of the file.

An e-mail program according to the present invention comprises the steps of: giving the OS a command to read out an index table in which 1) header information of each received e-mail message, 2) a path and file name of a message body file containing the message body of the e-mail message, and 3) a path and file name of an attached file or path and file names of attached files attached to the message body are recorded in association with one another,specifying,in response to a command to acquire an e-mail data set listed in the index table, 1) the path and file name of the corresponding message body file and 2) the path and file name(s) of the attached file(s) with reference to the index table, and giving the OS a command to read out the specified file.

An e-mail program according to the present invention comprises the steps of: A) reading out an index table in which the header information of each received e-mail message, a path and file name of a message body file containing the message body of the e-mail message, and a path and file name of an attached file or path and file names of attached files attached to the message body are recorded in association with one another, and,

B) in response to a command to display a list of stored e-mail messages, b1) specifying the path and file names of the message body files of the mail massages and their attached files listed in the index table with reference to the index table, b2) acquiring the names of files stored in the folders in which the e-mail message body files and their attached files listed in the index table are stored, and b3) indicating, when there are files other than the message body files and their attached files in the folders, the presence of the message body files and their attached files, and the other files in a distinguishable manner.

An e-mail program according to the present invention comprises the steps of: A) reading out an index table in which the header information of each received e-mail message, a path and file name of a message body file containing a message body of the e-mail message, and a path and file name of an attached file or path and file names of attached files attached to the message body are recorded in association with one another, and,

B) in response to a command to display the list of stored e-mail messages, b1) specifying the path and file names of the message body files of the mail massages and the attached file(s) listed in the index table with reference to the index table, b2) acquiring the names of files stored in the folders in which the e-mail message body files and their attached files listed in the index table are stored, and b3) indicating, when there are files other than the message body files and their attached files in the folders, the message body files and their attached files in association with each other.

An e-mail device for extracting and storing the header information and message body from a received e-mail message, comprises: means for converting the extracted message body into a message body file and storing the file in a file storing section, and means for adding a mail ID and header information of the e-mail message and file specifying information of its message body file into an index table.

An e-mail message moving device, comprises: A) a reading section for reading out an index table in which a1) header information of each received e-mail message, a2) a path and file name of a message body file containing a message body of the e-mail message, and a3) a path and file name of an attached file or path and file names of attached files attached to the message body are recorded in association with one another from a storage area, and B) a changing section for giving the OS a command, in response to a command to move a file stored in the storage area to a different folder, to move the file and to change the path name of the file in the index table to a name corresponding to the destination of the file.

An e-mail message reading device, comprises: a reading section for reading out an index table in which header information of each received e-mail message, a path and file name of a message body file containing a message body of the e-mail message, and a path and file name of an attached file or path and file names of attached files attached to the message body are recorded in association with one another, and a reading section for specifying, in response to a command to acquire an e-mail data set listed in the index table, the path and file name of the corresponding message body file and the path and file name(s) of the attached file(s) with reference to the index table and reading out the specified file.

An e-mail message storing method for extracting the header information and message body from a received e-mail message and storing them, comprises the steps of:converting and storing the extracted message body into a message body file, and adding a mail ID and header information of the e-mail message and file specifying information of its message body file into an index table.

An e-mail message moving method, comprises the steps of:A) reading out an index table in which a1) the header information of each received e-mail message, a2) a path and file name of a message body file containing the message body of the e-mail message, and a3) a path and file name of an attached file or path and file names of attached files attached to the message body are recorded in association with one another from a storage area, and B) giving the OS a command, in response to a command to move a file stored in the storage area to a different folder, to move the file and change the path name of the file in the index table to a name corresponding to the destination of the file.

An e-mail message reading method, comprises the steps of: reading out an index table in which 1) header information of each received e-mail message, 2) a path and file name of a message body file containing a message body of the e-mail message, and 3) a path and file name of an attached file or path and file names of attached files attached to the message body are recorded in association with one another, and specifying, in response to a command to acquire an e-mail data set listed in the index table, 1) the path and file name of the message body file and 2) the path and file name of the attached file or the path and file names of the attached files with reference to the index table and reading out the specified file.

In this specification, “OS” means operating system program. Also, “file specifying information” of a file, which means the location where the file is stored and the name of the file, is the folder name and the file name in the embodiments of the present invention. A “message body” herein is an e-mail message itself except for the header information, that is, the information that the sender of the e-mail message wants to transmit to the receiver, when the e-mail message has no attached file. When an e-mail message has attached files, a message body is the e-mail message itself except for the header information and the attached files. “An attached file or all of attached files” herein is, when an attached file is attached the message body, the attached file and are, when attached files are attached, the message body the attached files.

The feature, other objects, usage, effects of the present invention will be apparent from the following description of preferred embodiments as illustrated in the accompanying drawings.

### BRIEF DESCRIPTION OF THE DRAWINGS

FIG. 1 is a functional block diagram of an e-mail device 1 according to the present invention.

FIG. 2 is a view illustrating an example of hardware constitution of the e-mail device 1 constituted using a CPU.

FIG. 3 is a view illustrating the data structure of an index table.

FIG. 4 is a flowchart at the time of start-up.

FIG. 5 is a flowchart at the time of reception of an e-mail massage.

FIG. 6 is a view illustrating an example of header information of a received e-mail message.

FIG. 7 is a view illustrating the hierarchical structure of folders.

FIG. 8 is a flowchart of the procedure for displaying a message body by a mail program.

FIG. 9 is a view illustrating an example of screen displayed by the mail program.

FIG. 10 is a flowchart of the procedure for moving a file from a folder to another by the mail program.

FIG. 11 is a view illustrating an index table before and after the file movement.

FIG. 12 is a flowchart at the time of reception of an e-mail message in the case where HTML conversion is performed.

FIG. 13 is a template for HTML conversion.

FIG. 14 is a message body after HTML conversion.

FIG. 15 is a view illustrating the data structure of the index table in the case where HTML conversion is performed.

FIG. 16 is a message body after XML conversion.

FIG. 17 is a template for XML conversion.

### DETAILED DESCRIPTION OF THE PREFERRED EMBODIMENTS

Description of Functional Block Diagram

Description will be hereinafter made of an embodiment of the present invention with reference to the drawings.

An e-mail device 1 has a header information extracting section 3, a file creation command section 5, an adding section 9, an index table storing section 11, and a reading section 13.

The header information extracting section 3 extracts the header information from given e-mail message data. The file creation command section 5 allows a file management system 7 to convert the data of the e-mail message except the header information into a file so that the file management system 7 can take out the data as a block. The file converted from the data is stored in a file storing section 8. The adding section 9 adds the header information of the file converted from the data of each given e-mail message, together with its file name and path name, into an index table in the index table storing section 11. The file creation command section 5 stores the attached files separately and adds the file specifying information of the attached files into the index table when e-mail message has any attached files.

In response to an e-mail data list display command, the reading section 13 specifies the path and file names of the massage body files of the e-mail messages and their attached files listed in the index table in the index table storing section 11 with reference to the index table and gives the file management system 7 a command to acquire the names of files in the folders in which the e-mail message body files and their attached files listed in the index table are stored. When there are files other than the message body files and their attached files in the folders, the reading section 13 gives the file management system 7 a command to indicate the presence of the message body files and their attached files, and the other files in a distinguishable manner. The file management system 7 performs a display on a display section 6 according to the command.

In response to a command to acquire an e-mail data set listed in the index table in the index table storing section 11, the reading section 13 specifies the path and file name of the corresponding massage body file and the path and file names of its attached files with reference to the index table, and gives the file management system 7 a command to read out the specified file.

### 2. HARDWARE CONSTITUTION

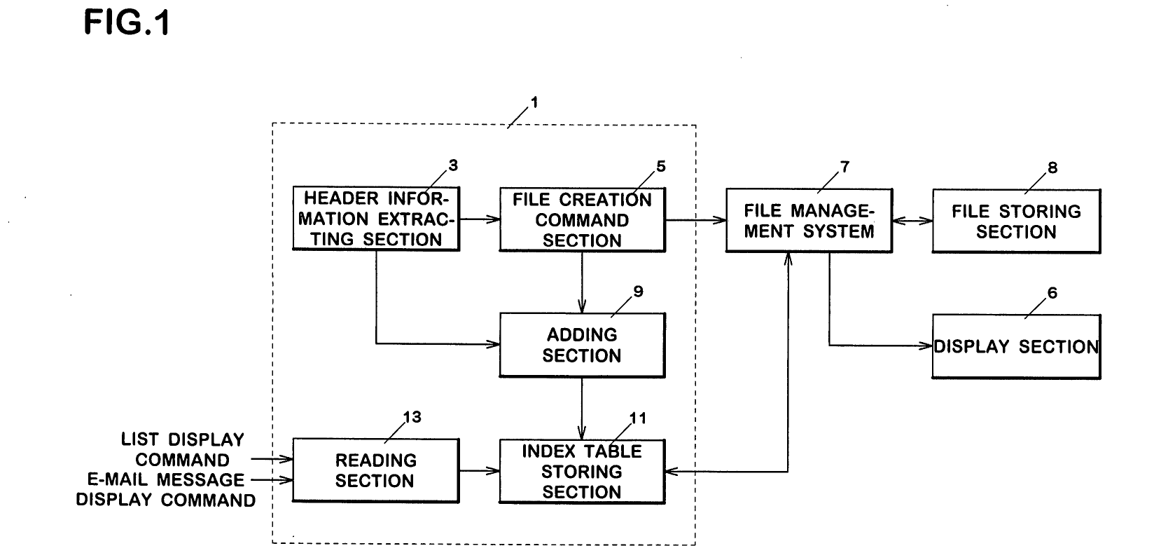

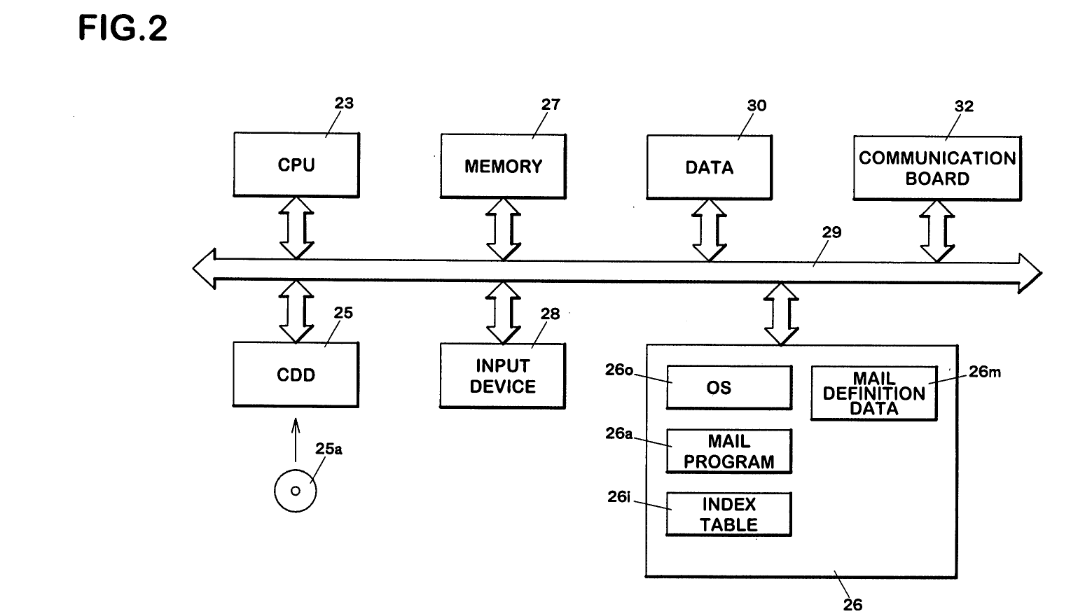

The hardware constitution of the e-mail device 1 shown in FIG. 1 will be described with reference to FIG. 2. FIG. 2 is an example of hardware constitution of the e-mail device 1 constituted using a CPU.

The e-mail device 1 has a CPU 23, a memory 27, a hard disk 26, a monitor 30, a CDD (CD-ROM drive) 25, an input device 28, a communication board 32, and a bus line 29. The CPU 23 controls each section via the bus line 29 according to programs stored in the hard disk 26.

An operating system program (which will be hereinafter referred to as OS) 26o, a mail program 26a, an index table 26i, and mail definition data 26m are stored in the hard disk 26.

In this embodiment, Windows XP (trademark) is used as the operating system program (OS) 26o. The program for performing reading and writing of files in the OS 26o constitutes the file management system shown in FIG. 1.

As the mail definition data 26m, definition data for storing sent and received e-mail messages in folders and definition data in the mail program such as the account, address book, mail sorting conditions (filtering conditions) are stored.

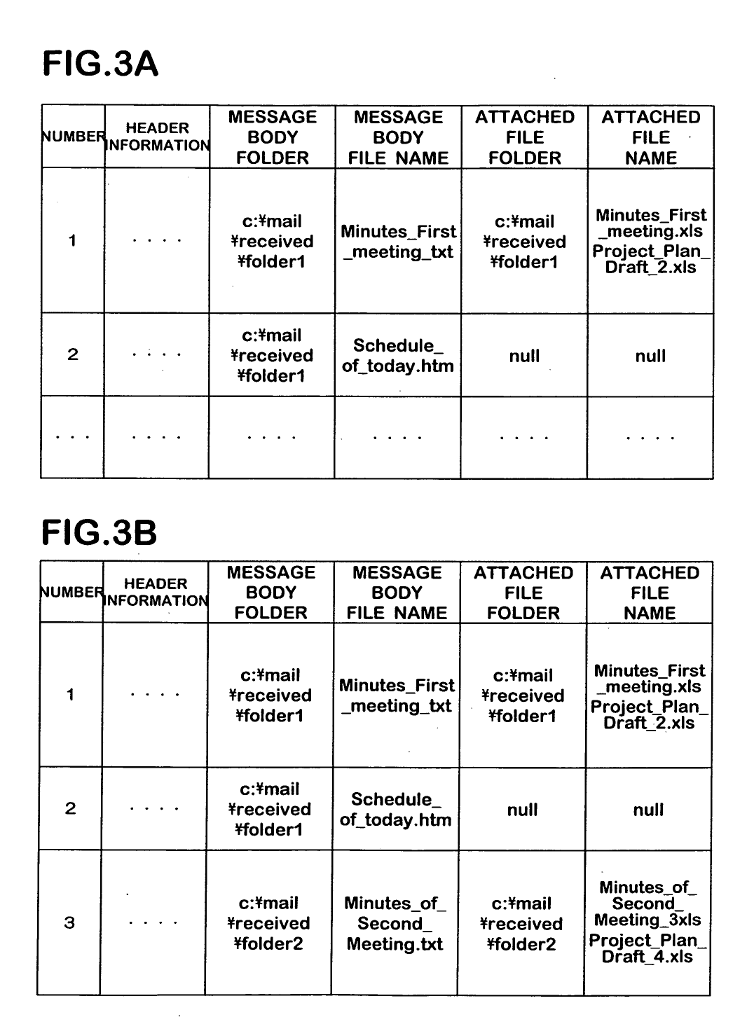

In the index table 26i, the header information, message body folder, message body file name, attached file folder, attached file names of each of the sent and received e-mail messages are stored in association with one another as shown in FIG. 3A. In the case of e-mail messages without attached files, “null” is given as the attached file folder and attached file name.

The mail program 26a sends and receives e-mail messages as an ordinary mail program does. The mail program 26a does not store message body of a plurality of received e-mail messages in one file as an ordinary mailer does but converts them into files separately. The details will be described later.

The programs have been read from a CD-ROM 25a on which the programs are recorded through the CDD 25 and installed into the hard disk 26. The programs may be installed into the hard disk from a recording medium, other than a CD-ROM, readable by a computer such as a flexible disk (FD) or IC card, or downloaded through a communication line.

Although the programs are installed into the hard disk 26 from a CD-ROM to allow the computer to execute the programs recorded on the CD-ROM indirectly in this embodiment, the present invention is not limited thereto. The computer may directly execute the programs recorded on the CD-ROM through the CDD 25. Programs excutable by a computer include programs which can be executed when installed, programs which have to be converted to a different form (for example, decompressing a compressed file), and programs which can be executed when combined with another module.

### 3. FLOWCHARTS

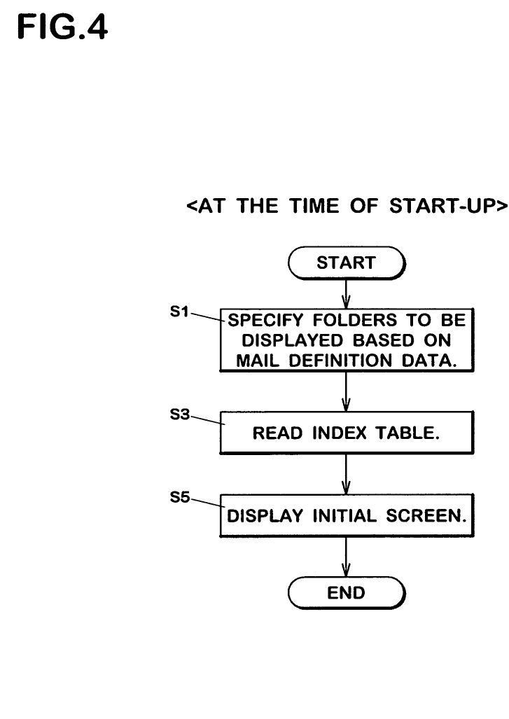

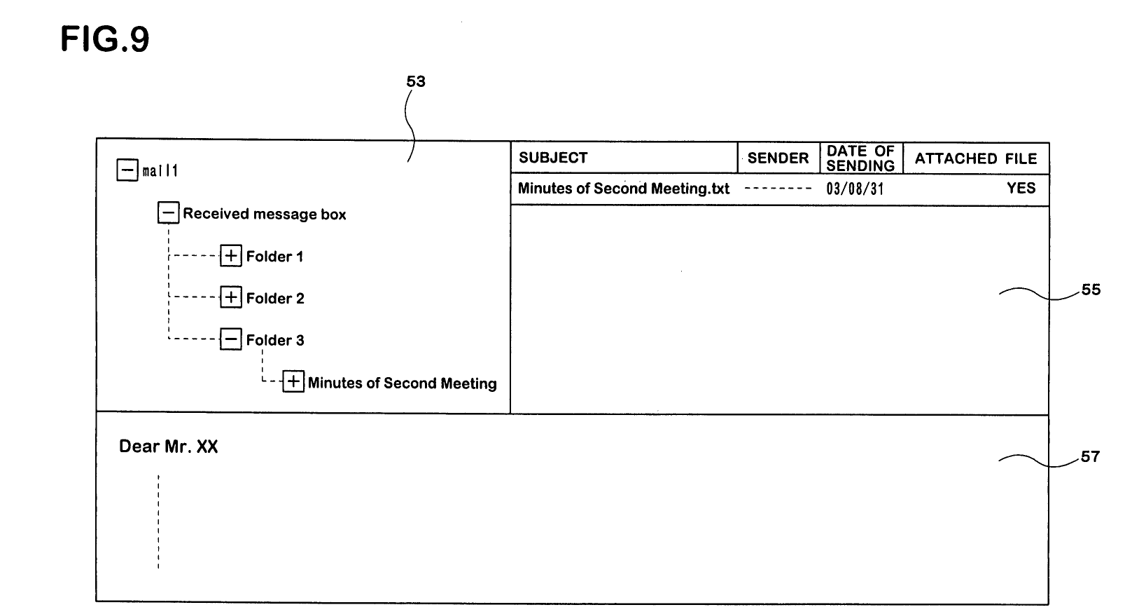

The data management process of the mail program 26a will be described with reference to FIG. 4. In response to a start-up command, the mail program 26a specifies the folders in which target data are stored based on the mail definition data 26m (step S1 in FIG. 4). The CPU 23 reads the current index table 26i (see FIG. 3A) (step S3 in FIG. 4). The CPU 23 displays an initial screen as conventional mail software does (step S5). In this embodiment, the initial screen is divided into three sections: folder list display section, e-mail message list display section, and viewer section in which e-mail message body are displayed (see FIG. 9). As shown in FIG. 9, the directory structure of folders managed by the mail program 26a, such as the received message folder, sent message folder and outgoing message folder, is displayed in a folder list display section 53 with reference to the mail definition data 26m. In an e-mail message list display section 55, the senders or receivers of the messages, time of receipt, subject and so forth are displayed with reference to the header information of e-mail messages as shown in FIG. 3A. In a mail massage body display section 57, the message body of an e-mail message is displayed as described in detail later.

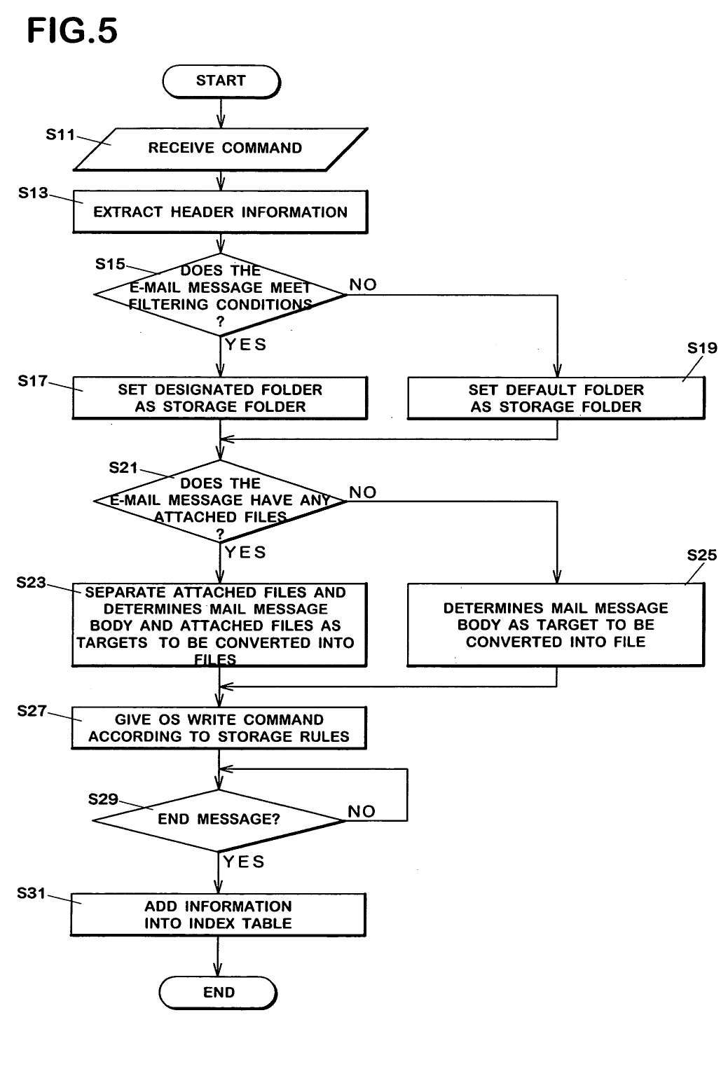

The process for storing a newly received e-mail massage will be described with reference to FIG. 5.

Description will be made of a case where an e-mail massage, with a subject of “Minutes_of_Second_Meeting,” having a message body saying “Dear Mr. XX, I am writing to send you the Minutes_of_Second_Meeting. Sincerely, YY” and attached files named Minutes_of_Second_Meeting.xls” and “Project_Plan_Draft_{—}4.xls” and sent from a sender “aaa@xxx.co.jp” at 1:39:57 PM on Aug. 13, 2003 (Japan time) is received by a recipient “bbb@yyy.co.jp”. No mail filtering condition is set.

In response to a reception start command (step S11 in FIG. 5), the CPU 23 extracts the header information from the incoming e-mail message (step S13 in FIG. 5), and determines whether it meets filtering conditions (step S15). In this example, no mail filtering condition is set, the default folder is set as the storage folder (step S19). In this embodiment, the default folder is “c:¥mail¥received¥folder3.”

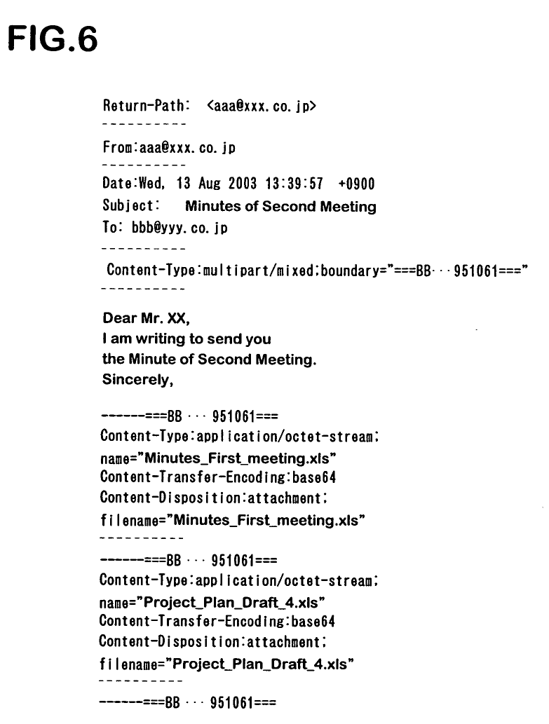

Then, the CPU 23 determines whether the e-mail message has any attached files (step S21). This determination is made in the same manner as in a conventional method. In this embodiment, an e-mail message is determined to have attached files when the herder information includes information which indicates that the content type is a multipart form. In this example, since there is information which indicates that the content type is a multipart form as shown in FIG. 6, the CPU 23 determines that the e-mail message has attached files. Then, the CPU 23 separates the attached files and determines the mail message body and the attached files as targets to be converted into files (step S23). As shown in FIG. 6, the two attached files are separated from the e-mail message body, and three sets of data to be converted into files are obtained.

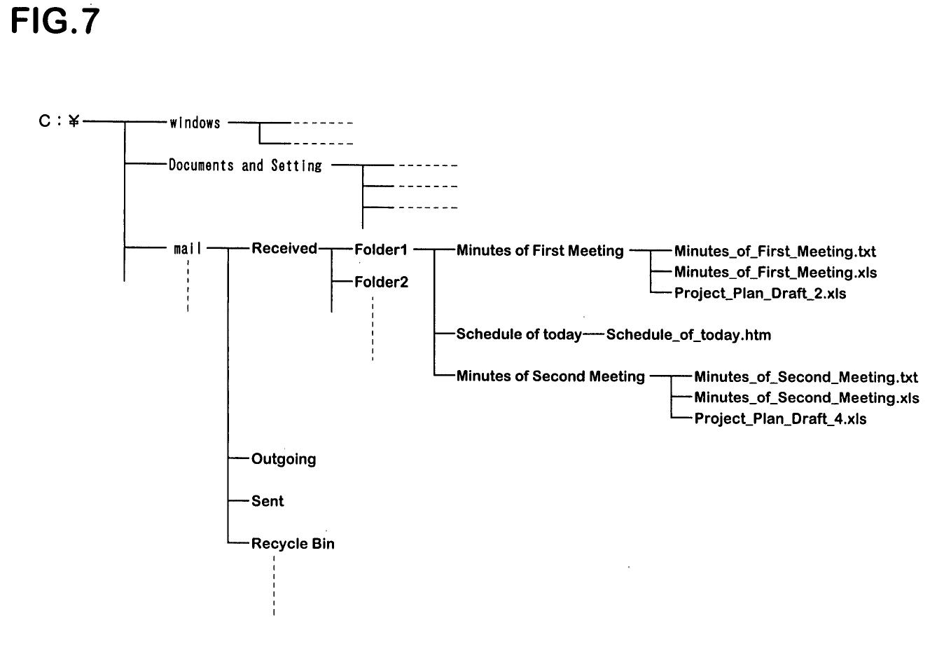

The CPU 23 gives a write command to the OS based on file storing rules (step S27 in FIG. 5). The file storing rules are rules about with what name and in which folder the files converted from the data will be stored. In this embodiment, a subfolder with the same name as the “Subject” included in the header information is created in a storage folder and the message body file and the attached files are stored in the subfolder. Thus, in this example, the CPU 23 causes the OS to create a subfolder named “¥ Minutes_of_Second_Meeting” in the default folder c:¥mail¥received¥folder3. Also, the CPU 23 gives the OS a command to store the message body file “Minutes_of_Second_Meeting.txt” and the attached files “Minutes_of_Second_Meeting.xls” and “Project_Plan_Draft_{—}4.xlsff in the subfolder “¥ Minutes_of_Second_Meeting.” The three files, that is the message body file “Minutes_of_Second_Meeting.txt, ” and attached files “Minutes_of_Second_Meeting.xls” and “Project_Plan_Draft_{—}4.xls,” are thereby stored in the folder “c:¥mail¥received¥folder3¥ Minutes_of_Second_Meeting” as shown in FIG. 7.

The CPU 23 determines whether an end message is given from the OS (step S29). When an end message is given, the CPU 23 adds information in the index table. As described before, in the index table, the header information, message body folder, message body file name, attached file folder, attached file names of each of the e-mail messages are stored in association with one another. Thus, the locations of the received e-mail message data are added in the index table as shown in FIG. 3B.

As described previously, in this embodiment, message body is converted into separate files and stored in a target folder. Thus, the OS can manage the e-mail message body as ordinary files. When an e-mail message has an attached file(s), the attached file(s) is stored in the same folder as the corresponding message body file.

Since e-mail message data and attached files received through e-mail are managed, not in the data structure unique to a mail program, but as files manageable by ordinary OSs, data received through e-mail and data obtained through means other than e-mail can be managed collectively without creating an additional data area. For example, a file downloaded from an FTP server and relating to a message body file or an attached file can be stored in the same folder.

Also, data for the mail program can be accessed by a different application program. In addition, since a message body file and its attached files are stored in a folder with the same name as the message body file, the file management system of the OS can judge the relation between them by the location in which the files are stored.

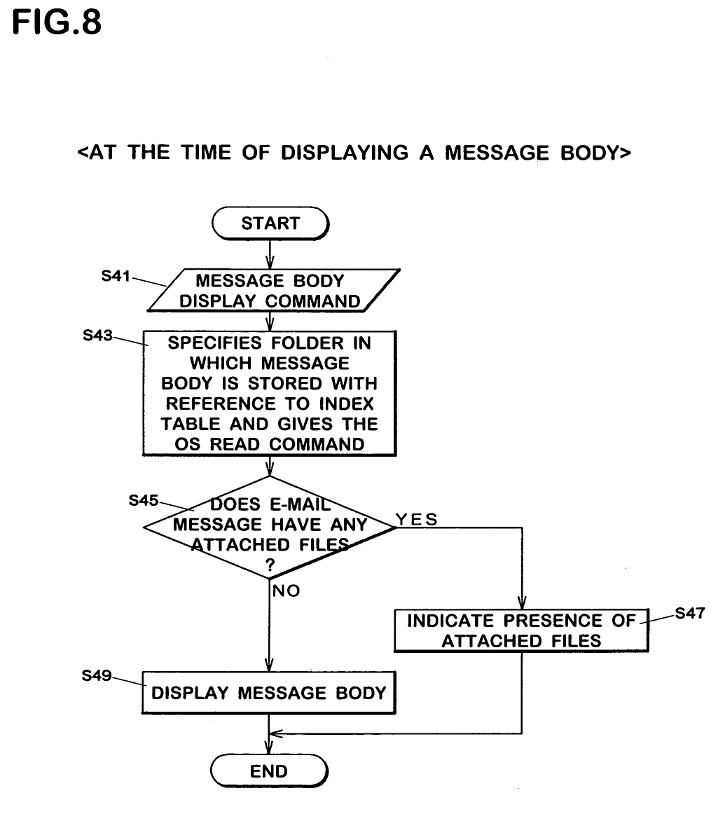

Next, the process for displaying an e-mail message body will be described with reference to FIG. 8. The following description will be made on the assumption that the list of e-mail messages has been displayed in the e-mail message list display section 55 with reference to the index table as shown in FIG. 9, and the message body file “Minutes_of_Second_Meeting.txt” is selected to be displayed.

The operator selects an e-mail message from the displayed list of e-mail messages and gives a message body display command (step S41). The CPU 23 specifies the folder in which the files relating to the specified e-mail message are stored with reference to the index table, and gives a read command to the OS (step S43). The files relating to an e-mail message are the message body file and its attached files.

The CPU 23 refers the index table and determines whether the designated e-mail message has any attached files (step S45). When the designated e-mail message has attached files, the CPU 23 displays the content of the e-mail message in the viewer section 57 and indicates the presence of attached files (step S47).

The presence of attached files can be indicated by, for example, displaying a symbol showing that there are attached files. To display the content of an attached file, the operator clicks on the symbol as in the conventional manner. On clicking the symbol, the CPU determines whether there is an application program associated with the file. When there is such an application program, the application program is started and the content of the attached file is displayed.

When the attached file is data in a specific file format, the CPU may automatically display the content of it in the viewer section 57. The mail program may be configured to display a message body and its attached file or files in response to a command to read the message body.

When the e-mail message data have no attached file, the process goes from step S45 to step S49, and the content of the message body file is displayed in the viewer section 57 (step S49).

As described above, when a message body and its attached files are separately converted into files, the contents of the files can be displayed on a viewer screen by referring the index table.

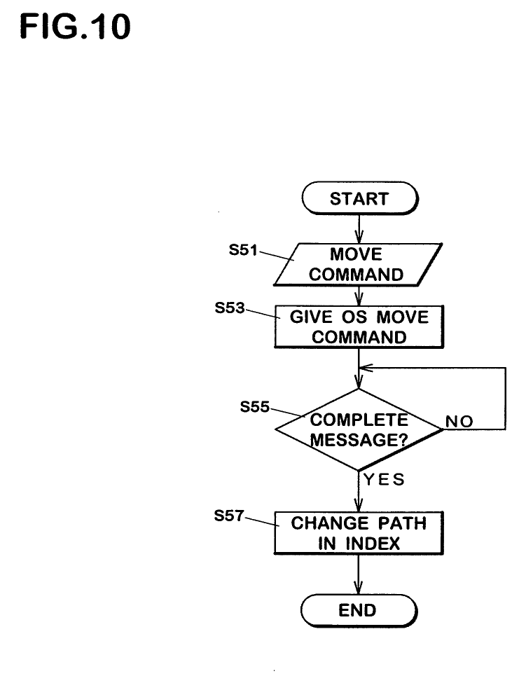

Next, the process at the time when a file is moved from a folder to another will be described with reference to FIG. 10.

Description will be made of a case where the directory structure has been displayed in the folder list display section 53 as shown in FIG. 9, and the entire message body folder “¥ Minutes_of_Second_Meeting” containing the message body file “Minutes_of_Second_Meeting.txt” and its attached files and stored in the folder “c:¥mail¥received¥folder3” is moved to a folder “c:¥mail¥received¥folder1.”

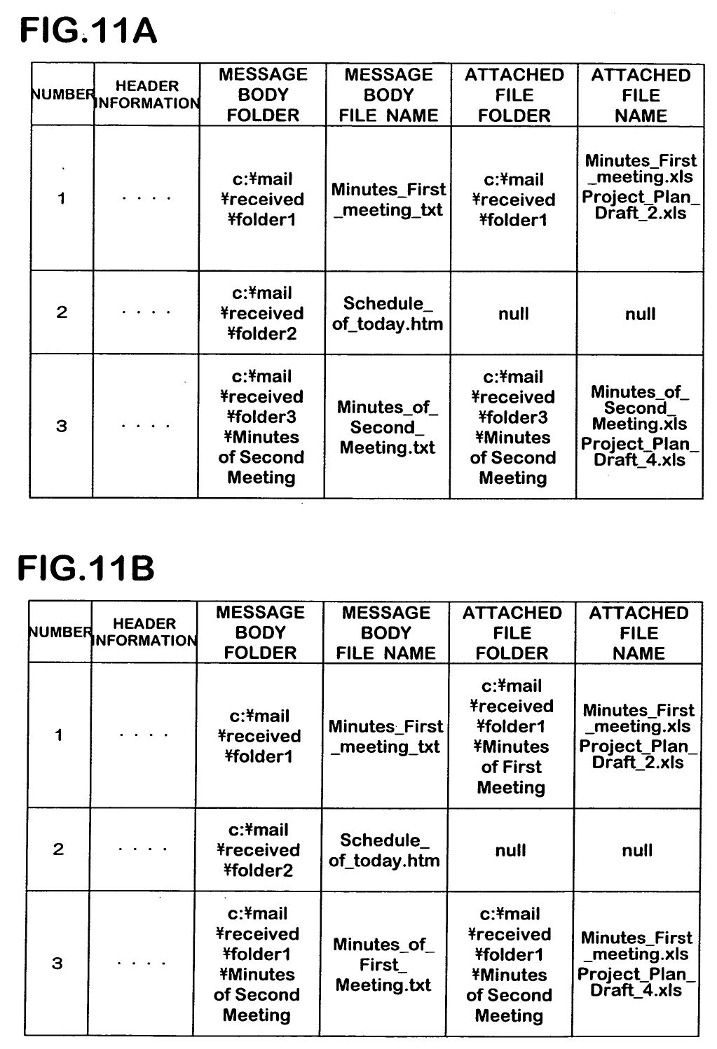

The operator gives a move command designating the files to be moved and the folder into which the files will be moved (step S51 in FIG. 10). More specifically, the operator selects the folder “c:¥mail¥received¥folder3¥ Minutes_of_Second_Meeting” containing the message body file “Minutes_of_Second_Meeting.txt” and the attached files “Minutes_of_Second_Meeting.xls” and “Project_Plan_Draft_{—}4.xls” to be moved with an input/output device, and drags and drops the folder onto the folder “c:¥mail¥received¥folder1.” The CPU 23 gives the OS a command to move the files (step S53). The CPU 23 determines whether a movement complete message is given from the OS (step S55). On receiving the message, the CPU 23 changes the path names in the index table (step S57). The storage folder in the index table is thereby changed from the state shown in FIG. 11A to the state shown in FIG. 11B. As described above, when e-mail message data are moved from one folder to another, since the index table is changed together, the e-mail message can be managed.

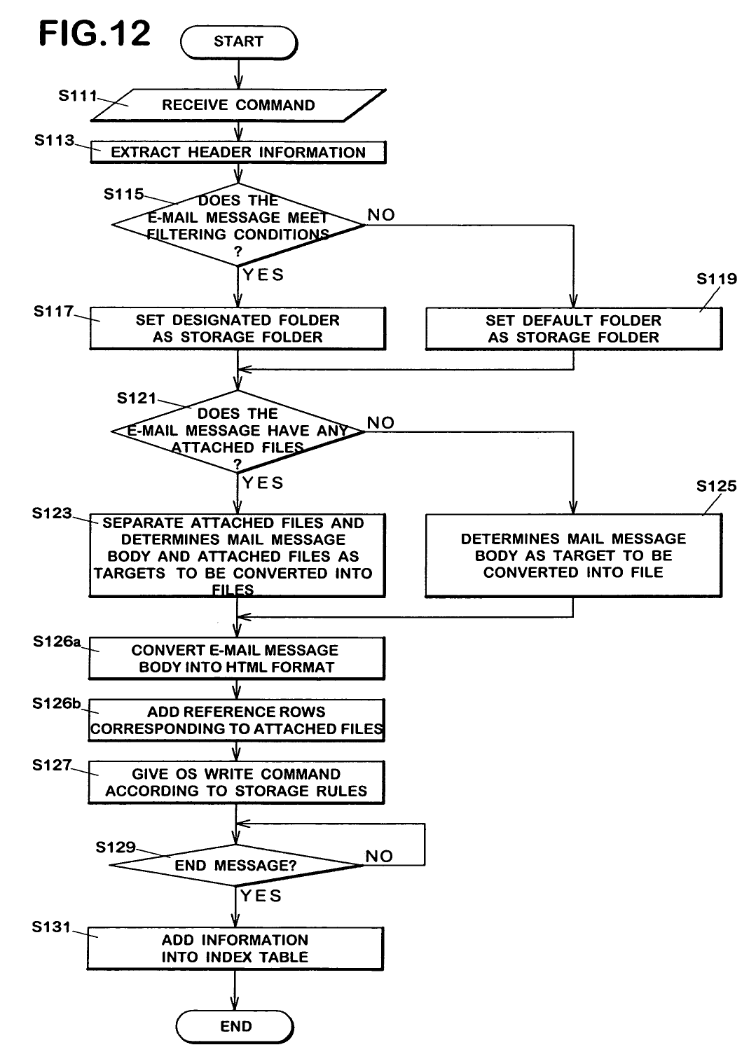

Although a message body file and its attached files are associated with each other by storing the path and file names of attached files into the index table for each e-mail message in this embodiment, a message body file and its attached files may be associated with each other by any method. For example, a method may be used in which each message body is converted into HTML format and link destination information is added to the file. In this case, steps of converting the message body into HTML format and adding reference rows corresponding to the attached files to the converted file are added between step S23 and step S27 in FIG. 5. FIG. 12 shows a flowchart in this case. Steps S126a and S126b are added.

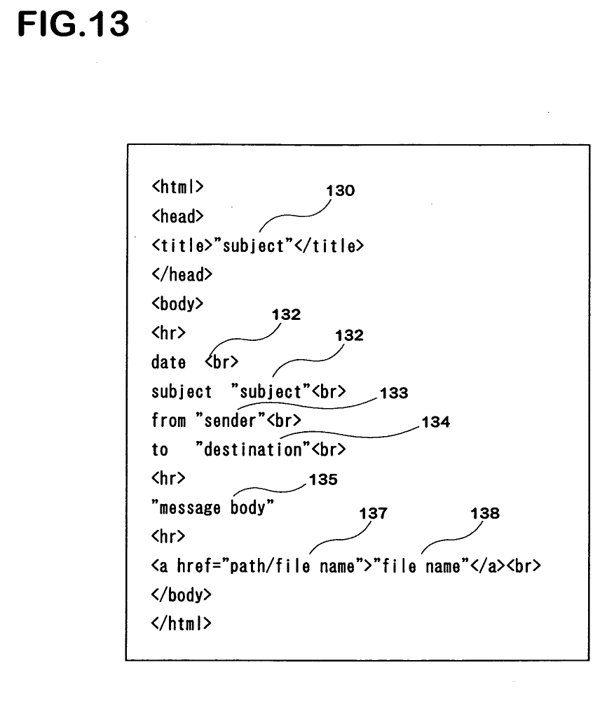

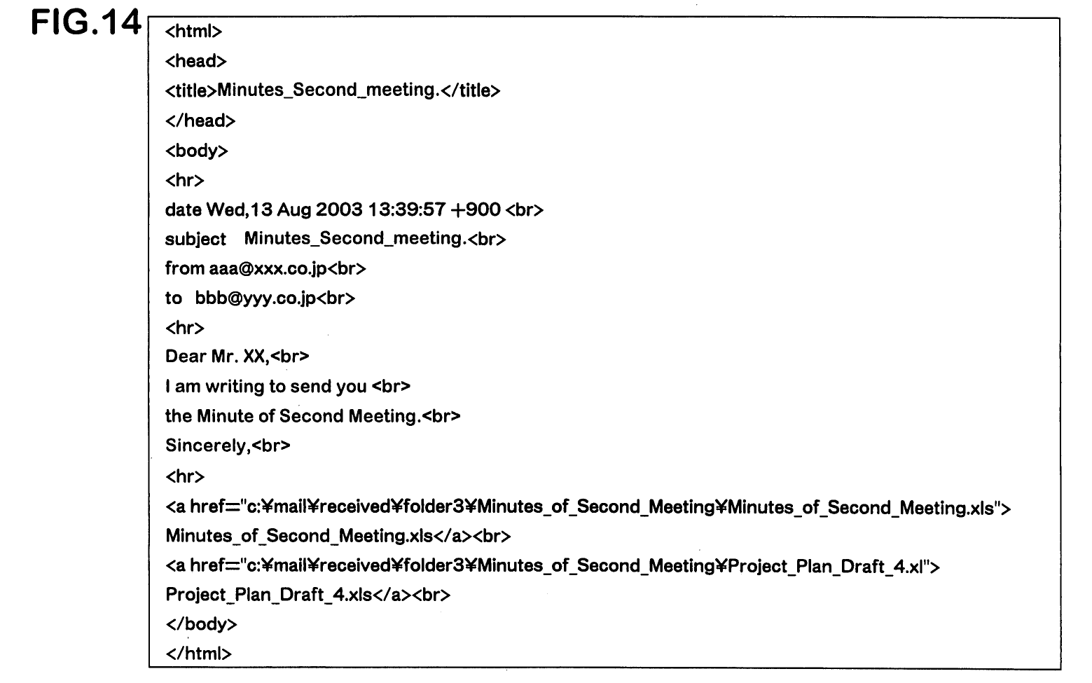

In this embodiment, a template for HTML conversion as shown in FIG. 13 is recorded in advance, and a message body is converted into HTML format by extracting “date,” “subject,” “sender,” “destination” and “message body” from a received e-mail message and storing them in fields 130 to 135 as shown in FIG. 13. A reference row as described above is added by writing the path name and attached file name for use in storing the attached file in a field 137 and the attached file name in a field 138. In the case of an e-mail message having a plurality of attached files, the same number of pieces of link destination information as the attached files are created and added according to the link setting template. As a result, HTML format data as shown in FIG. 14 are created.

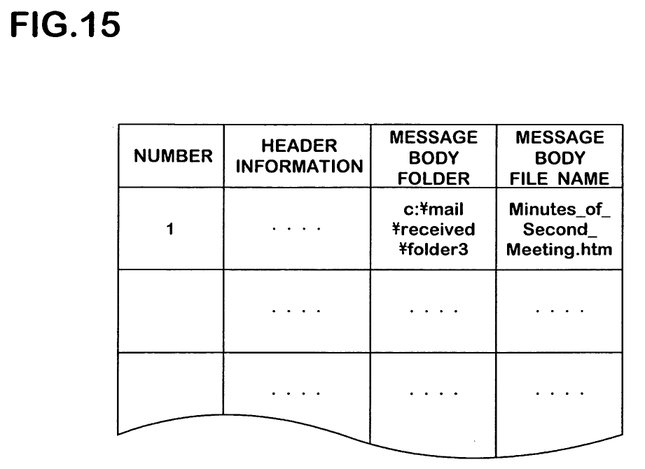

The processes in and after step S127 are the same as those shown in FIG. 5, their description will be omitted. The line feed tags at the end of the lines of the message body shown in FIG. 14 are line feed tags in HTML format converted from the line feed tags in the original message body. FIG. 15 shows the index table in the case where link destination information is added to a message body. As shown in FIG. 15, items regarding attached files are not necessary in the index table. When a message body file is specified with reference to the index table in reading, its attached files can be specified based on the link information in the message body file. The displaying process is the same as that in the embodiment described before, and, therefore, its description will be omitted. When an attached file is moved from the original folder to another, it is necessary to rewrite the link destination information in the corresponding message body file.

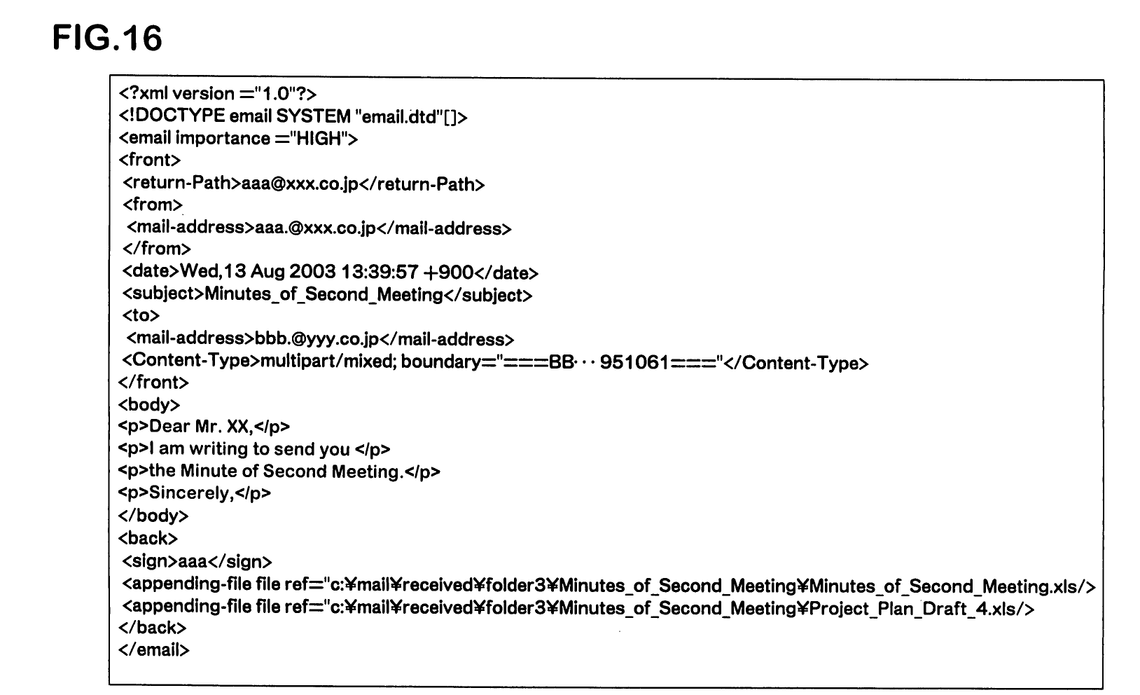

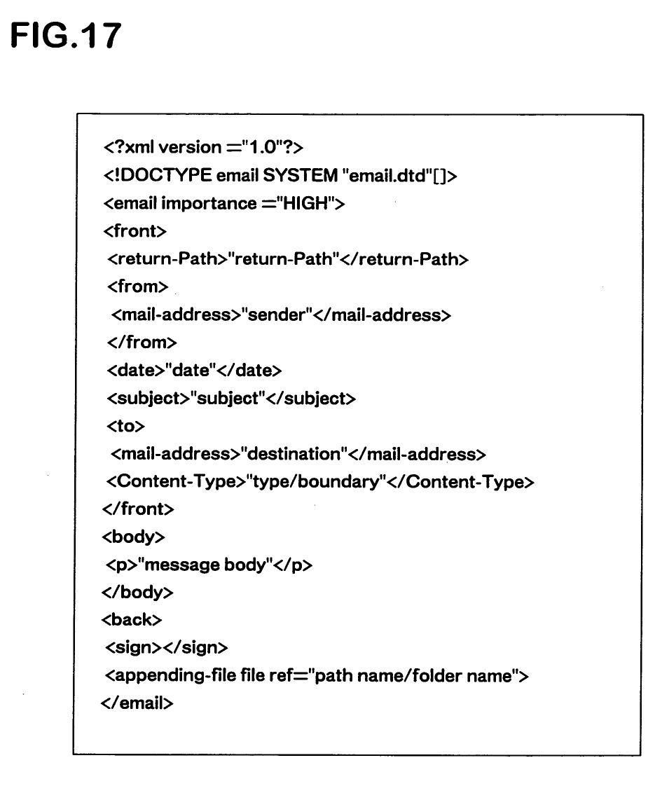

Although the message body is converted into HTML format in the above embodiment, the message body may be converted into XML format. FIG. 16 shows the data structure of a message body file after XML conversion. The conversion to XML format is made by extracting necessary data from an e-mail message and writing them in a template for XML conversion prepared in advance as shown in FIG. 17 as in the case of the HTML conversion. XML format is advantageous since, unlike HTML format, tags can be used without restriction.

Although the link destination information is attached to the bottom of the message body file in this embodiment, the location of the link destination information is not limited thereto as long as it is included in the message body file.

### 4. OTHER EMBODIMENT

In the above embodiment, since the message body of each e-mail message is stored as one file, such files may be moved to another folder by another application program. In such a case, the e-mail message may not be able to be displayed with the mail program. To prevent this from happening, a warning message may be displayed or the index may be automatically changed after a file has been moved. Such movement of files may be prohibited. Alternatively, the mail program may be configured to check whether any files have been moved and change the index table automatically when started.

In the above embodiment, information obtained through e-mail and information obtained through means other than e-mail can be managed comprehensively without a need for extra storage capacity, and information obtained from another application program through e-mail can be also viewed. When the mail program can display files which are in the folders managed by the e-mail program but not listed in the index table, information obtained through means other than e-mail can be viewed with the e-mail program.

Although a subfolder with the same name as the message body file is created in a storage folder in the above embodiment, the names of the subfolders are not limited thereto. Serial numbers or dates may be used.

When the attached file or all the attached files of a message body file are stored in a subfolder in the folder in which the message body file is contained, the relation between the message body file and its attached file or files can be represented by the folder structure. In this case, the folder name or names of the attached file or files can be omitted from the index table. This is also the case when a folder is created for each message body file and the attached file or files of the message body file are stored in the folder.

A message body file and its attached files may be stored in a designated folder without creating a subfolder. A message body file and its attached files may be stored in different folders designated for each type of files.

The message body files, which are text files in the above embodiment, may be files with display format information such as HTML data and XML data.

The header information of e-mail messages managed by the mail program, which is recorded in the index table in the above embodiment, may be recorded in a specified location in each message body file (at the top, for example), or stored as files separately or in groups.

When a shared folder for a plurality of users is created and e-mail messages which meet a filtering condition are stored in the folder, the e-mail messages can be accessed by all the users. Also, each e-mail message is stored as a file separately, the e-mail messages can be referred to by an application program other than the mail program.

When the mail program specifies the path and file names of the massage body files of the e-mail messages and their attached files listed in the index table with reference to the index table and gives the OS a command to acquire the name of files contained in the folders in which the e-mail message body files or their attached files listed in the index table are stored in response to an e-mail data list display command, and when files other than the message body files and attached files are contained in the folders, the mail program may give the OS a command to display the files in association with the message body files and their attached files. Then, the files related to the e-mail message body file other than the attached files can be displayed together while the mail program is operating.

Although description will be made of the case in which the entire folder containing a message body file and its attached files is moved into another folder in the above embodiment, the present invention is not limited thereto. Only a message body file and its attached files may be moved, or either a message body file or its attached files may be moved.

In the above embodiment, the mail program does not read an attached file or files of a message body in response to a command to open the message body and reads an attached file in response to a command to open it. However, the mail program may be configured to open the attached file or files of a message body in response to a command to read the message body.

In this embodiment, a CPU and software is used to realize the function shown in FIG. 1. However, part of or the entire function may be realized by hardware such as a logic circuit.

Part of the operation of the mail program may be performed by the operating system (OS).

An e-mail program according to the present invention is a program for extracting the header information and message body from a received e-mail message and storing them to cause a computer to manage the e-mail message, and has the following steps: 1) a file creating and storing step of converting the extracted message body into a message body file and storing it so that the OS can take out the data as a block, and 2) an index adding step of adding the mail ID and header information of the e-mail message and the file specifying information of its message body file into an index table. Since the message body is stored as a message body file so that the OS can take out the message body as a block, information obtained through e-mail and the information obtained through means other than e-mail can be managed comprehensively without a need for an extra data area.

When the e-mail message has at least one attached file, the e-mail management program according to the present invention causes the OS to store the attached file separately so that the OS can take out each of the attached file as a block in the file creating and storing step, and adds the file specifying information of the attached file into the index table in the index adding step. Thus, even when the e-mail message has attached file, information obtained through e-mail and the information obtained through means other than e-mail can be managed comprehensively without a need for an extra data area.

The e-mail management program according to the present invention stores the message body file and its attached file(s) in the same folder. Thus, the relation between the message body and its attached file can be known from the data storage structure.

The e-mail management program according to the present invention stores the attached file(s) attached to the message body file in a subfolder created in the folder in which the message body file is stored. Thus, the relation between the message body and its attached file(s) can be known from the data storage structure.

An e-mail management program according to the present invention is a main management program for extracting the header information and message body from a received e-mail message and storing them to cause a computer to manage the e-mail message, and has the steps of: giving the OS a file creating and storing command to convert the extracted message body into a message body file and storing it so that the OS can take out the data as a block, and giving the OS an index adding command to add the mail ID and header information of the e-mail message and the file specifying information of its message body file into an index table. Since the mail management program gives the OS a command to store the message body as a message body file so that it can take out the data as a block, information obtained through e-mail and the information obtained through means other than e-mail can be managed comprehensively without a need for an extra data area.

The program according to the present invention is a program which causes a computer to function as an e-mail device, and which A) gives the OS a command to read out an index table in which the header information of each received e-mail message, the path and file name of a message body file containing the message body of the e-mail message, and the path and file name(s) of attached file(s) attached to the message body are recorded in association with one another from a storage area, and B) gives the OS a command, in response to a command to move a file stored in the storage area to a different folder, to move the file and to change the path name of the file in the index table to a name corresponding to the destination of the file. Thus, when each set of message body is stored as a message body file so that the OS can take out the data as a block, the file can be moved from one folder to another.

The program according to the present invention is a program which causes a computer to function as an e-mail device, and which gives the OS a command to read out an index table in which the header information of each received e-mail message, the path and file name of a message body file containing the message body of the e-mail message, and the path and file name(s) of attached file(s) attached to the message body are recorded in association with one another, specifies, in response to a command to acquire an e-mail data set listed in the index table, the path and file name of the corresponding message body file and the path and file names of its attached file(s) with reference to the index table, and gives the OS a command to read out the specified file. Thus, when each set of message body is stored as a message body file so that the OS can take out the data as a block, the message body file and its attached file(s) can be read out.

The program according to the present invention is a program which causes a computer to function as an e-mail device, and which A) reads out an index table in which the header information of each received e-mail message, the path and file name of a message body file containing the message body of the e-mail message, and the path and file name(s) of attached file(s) attached to the message body are recorded in association with one another, and, B) in response to a command to display the list of e-mail messages, b1) specifies the path and file names of the message body files of the mail massages and their attached files listed in the index table with reference to the index table, b2) acquires the names of files stored in the folders in which the e-mail message body files and their attached files listed in the index table are stored, and b3) indicates, when there are files other than the message body files and their attached files in the folders, the presence of the message body files and their attached files, and the other files in a distinguishable manner. Thus, information obtained through e-mail and the information obtained through means other than e-mail can be displayed in a distinguishable manner.

The program according to the present invention is a program which causes a computer to function as an e-mail device, and which A) reads out an index table in which the header information of each received e-mail message, the path and file name of a message body file containing the message body of the e-mail message, and the path and file names of attached files attached to the message body are recorded in association with one another, and, B) in response to a command to display the list of stored e-mail messages, b1) specifies the path and file names of the message body files of the mail massages and their attached files listed in the index table with reference to the index table, b2) acquires the names of files stored in the folders in which the e-mail message body files and their attached files listed in the index table are stored, and b3) displays, when there are files other than the message body files and their attached files in the folders, the message body files and their attached files in association with each other. Thus, a message body file and its attached files can be displayed in association with each other.

An e-mail device according to the present invention is a device for extracting the header information and message body from a received e-mail message and storing them to manage the e-mail message, and has 1) means for converting the extracted message body into a message body file and storing it in a file storing section so that the OS can take out the data as a block, and 2) means for adding the mail ID and header information of the e-mail message and the file specifying information of its message body file into an index table. Since the message body is stored as a message body file so that the OS can take out the message body as a block, information obtained through e-mail and the information obtained through means other than e-mail can be managed comprehensively without a need for an extra data area.

The e-mail message managing method according to the present invention is an e-mail message managing method in which the header information and message body are extracted from a given e-mail message and stored to manage the e-mail message in a computer, and has the steps of 1) storing the extracted message body as a message body file in file storage means so that the OS take out the data as a block, and 2) adding the mail ID and header information of the e-mail message and the file specifying information of its message body file into an index table. Since the message body are stored as a message body file so that the OS can take out the message body as a block, information obtained through e-mail and the information obtained through means other than e-mail can be managed comprehensively without a need for an extra data area.

Description has been made of the preferred embodiments of the present invention for the purpose of illustration but not limitation. It should be understood that many changes and modification can be made within the scope of the appended claims without departing from the scope and spirit of the present invention.

1. An e-mail program for extracting and storing a header information and a message body from a received e-mail message, comprising the steps of:
a file creating and storing step of converting the extracted message body into a message body file and storing the file,
an index adding step of adding a mail ID and the header information of the e-mail message and the file specifying information of the message body file into an index table, and
a file specifying and reading step of specifying, in response to a command to acquire an e-mail data set listed in the index table, a path and file name of the corresponding message body file with reference to the index table and reading the specifying file.

2. An e-mail program for extracting and storing a header information and a message body from a received e-mail message, comprising the steps of:
a file creating and storing step of converting the extracted message body into a message body file and storing the file, and
an index adding step of adding a mail ID and header information of the e-mail message and a file specifying information of the message body file into an index table.

3. The e-mail program as set forth in claim 2, wherein, when the e-mail message has one attached file or attached files, the program extracts the attached file or all of the attached files and stores the attached file or all of the attached files separate from the message body file in the file creating and storing step, and adds the file specifying information of the attached file or files into the index table in the index adding step.

4. The e-mail program as set forth in claim 3, wherein the message body file and the attached file or files are stored in the same folder.

5. The e-mail program as set forth in claim 2, wherein the attached file or files attached to the message body file is stored in a subfolder created in the folder in which the message body file is stored.

6. The e-mail program as set forth in claim 2, wherein, when the e-mail message has one attached file or attached files, the program extracts the attached file and stores the attached file or the attached files separate from the message body file in the file creating and storing step, and adds the file specifying information of the attached file or attached files embodied link tag into the message body file in the index adding step.

7. An e-mail message storing program for giving commands to an OS extracting and storing the header information and message body from a received e-mail message, comprising the steps of:
giving the OS a file creating and storing command to convert and store the extracted message body into a message body file, and
giving the OS an index adding command to add the mail ID and header information of the e-mail message and the file specifying information of the message body file into an index table.

8. An e-mail program for extracting and storing a header information, a message body and one attached file or all of attached files from a received e-mail message, comprising the steps of:
a step of converting the extracted message body into a e-mail message and storing the message body file,
a step of extracting the attached file or all of the attached files from the e-mail message and storing the attached file or attached files separate from the message body file,
a step of adding a mail ID and header information of the e-mail message and a file specifying information of the message body file into an index table, and
a step of linking the message body file and the attached file so that an OS is able to read out the message body file and the attached file or all of the attached files.

9. The e-mail program as set forth in claim 8, wherein, the program adds the file specifying information of the attached file embodied link tag into the message body file in the linking step.

10. The e-mail program as set forth in claim 8, wherein, the program adds the file specifying information of the attached file into the index table in the linking step.

11. An e-mail program recording an index table in which a1) a header information of each received e-mail message, a2) a path and file name of a message body file containing the message body of the e-mail message, and a3) a path and file name of an attached file or path and file names of all of attached files attached to the message body are recorded in association with one another in a storage area, giving OS a command to read out the header information of each received e-mail message, the path and file name of a message body file containing the message body of the e-mail message, and the path and file names of one attached file or all of attached files attached to the message body are recorded in association with one another reference with the index table, and
giving the OS a command, in response to a command to move a file stored in the storage area to a different folder, to move the file and to change the path name of the file in the index table to a name corresponding to the destination of the file.

12. An e-mail program,
giving the OS a command to read out an index table in which a header information of each received e-mail message, a path and file name of a message body file containing a message body of the e-mail message, and a path and file name of an attached file or path and file names of all of attached files attached to the message body are recorded in association with one another,
specifying, in response to a command to acquire an e-mail data set listed in the index table, the path and file name of the corresponding message body file and the path and file names of its attached file or all of the attached files with reference to the index table, and
giving the OS a command to read out the specified file.

13. An e-mail program,
recording an index table in which a1) a header information of each received e-mail message, a2) a path and file name of a message body file containing the message body of the e-mail message, and a3) a path and file name of an attached file or path and file names of all of attached files attached to the message body are recorded in association with one another in a storage area,
in response to a command to display the list of stored e-mail messages,
specifying the path and file names of the message body files of the mail massages and the attached file or all of attached files listed in the index table with reference to the index table,
acquiring the names of files stored in the folders in which the e-mail message body files and the attached file and their attached files listed in the index table are stored, and
indicating, when there are files other than the message body files and their attached files in the folders, the presence of the message body files and the attached file or all of the attached files, and the other files in a distinguishable manner.

14. An e-mail program,
A) reading out an index table in which a header information of each received e-mail message, a path and file name of a message body file containing the message body of the e-mail message, and the path and file name of the attached file or the path and file names of all of the attached files attached to the message body are recorded in association with one another, and,
B) in response to a command to display a list of stored e-mail messages,
b1) specifying the path and file names of the mail massages and the attached file or all of the attached files listed in the index table with reference to the index table,
b2) acquiring the names of files stored in the folders in which the e-mail message body files and the attached file or all of the attached files listed in the index table are stored, and
b3) indicating, when there are files other than the message body files and the attached file or all of attached files in the folders, the message body files and the attached file or all of the attached files in association with each other.

15. An e-mail device for extracting and storing a header information and a message body from a received e-mail message, comprising:
means for converting the extracted message body into a message body file and storing the file in a file storing section, and
means for adding the mail ID and header information of the e-mail message and the file specifying information of its message body file into an index table.

16. An e-mail message moving device, comprising:
A) a reading section for reading out an index table in which a1) a header information of each received e-mail message, a2) a path and file name of a message body file containing a message body of the e-mail message, and a3) a path and file name of an attached file or path and file names of all of attached files attached to the message body are recorded in association with one another from a storage area, and
B) a changing section for giving the OS a command, in response to a command to move a file stored in the storage area to a different folder, to move the file and to change the path name of the file in the index table to a name corresponding to the destination of the file.

17. An e-mail message reading device, comprising:
a reading section for reading out an index table in which 1) a header information of each received e-mail message, 2) a path and file name of a message body file containing the message body of the e-mail message, and 3) a path and file name of attached file or path and file names of attached files attached to the message body are recorded in association with one another, and
a reading section for specifying, in response to a command to acquire an e-mail data set listed in the index table, 1) the path and file name of the corresponding message body file and 2) the path and file names of its attached files with reference to the index table and reading out the specified file.

18. An e-mail message storing method for extracting a header information and message body from a received e-mail message and storing them, comprising the steps of:
converting and storing a extracted message body into a message body file, and
adding a mail ID and header information of the e-mail message and a file specifying information of its message body file into an index table.

19. An e-mail message moving method, comprising the steps of:
A) reading out an index table in which a1) a header information of each received e-mail message, a2) a path and file name of a message body file containing the message body of the e-mail message, and a3) a path and file name of one attached file or path and file names of attached files attached to the message body are recorded in association with one another from a storage area, and
B) giving the OS a command, in response to a command to move a file stored in the storage area to a different folder, to move the file and change the path name of the file in the index table to a name corresponding to the destination of the file.

20. An e-mail message reading method, comprising the steps of:
reading out an index table in which 1) a header information of each received e-mail message, 2) a path and file name of a message body file containing the message body of the e-mail message, and 3) a path and file name of an attached file or path and file names of attached files attached to the message body are recorded in association with one another, and
specifying, in response to a command to acquire an e-mail data set listed in the index table, 1) the path and file name of the message body file and 2) the path and file name of the attached file or the path and file names of its attached files with reference to the index table and reading out the specified file.
